(19) United States
(12) Patent Application Publication
(10) Pub. No.: US 2026/0148102 A1
(43) Pub. Date: May 28, 2026

(54) Systems and Methods for Subgraph Matching Using Active Learning

(71) Applicant: The Regents of the University of California, Oakland, CA (US)

(72) Inventors: Andrea Bertozzi, Santa Monica, CA (US); Yurun Ge, Los Angeles, CA (US)

(73) Assignee: The Regents of the University of California, Oakland, CA (US)

(21) Appl. No.: 19/122,646

(22) PCT Filed: Oct. 18, 2023
(86) PCT No.: PCT/US2023/077234

§ 371 Date: Apr. 18, 2025

Related U.S. Application Data
(60) Provisional application No. 63/379,989, filed on Oct. 18, 2022.

(51) Int. Cl. G06N 5/022

(52) U.S. Cl. CPC G06N 5/022

(57) ABSTRACT

Systems and methods for subgraph matching using active learning in accordance with embodiments of the invention are illustrated. One embodiment includes a method for subgraph matching with active learning. The method includes steps for encoding vertices of a world graph into a plurality of candidate sets, applying a first filter to each of the plurality of candidate sets to reduce the number of candidates in each of the plurality of candidate sets, querying for a template vertex in a corresponding candidate set from the plurality of candidate sets, determining a final candidate matching the corresponding template vertex for each of the plurality of the candidate sets, and returning a number of total queries made.

### CROSS-REFERENCE TO RELATED APPLICATIONS

The current application claims the benefit of and priority under 35 U.S.C. § 119 (e) to U.S. Provisional Patent Application No. 63/379,989 entitled “Active Learning for the Subgraph Matching Problem” filed Oct. 18, 2022. The disclosure of U.S. Provisional Patent Application No. 63/379,989 is hereby incorporated by reference in its entirety for all purposes.

### STATEMENT OF FEDERAL SUPPORT

This invention was made with government support under Grant Number 2027277, awarded by National Science Foundation and under Grant Number FA8750-18-2-0066, awarded by the U.S. Department of Defense, Defense Advanced Research Projects Agency. The government has certain rights in the invention.

### FIELD OF THE INVENTION

The present invention generally relates to graph theory, more specifically, the invention relates to subgraph matching using supervised machine learning algorithms.

### BACKGROUND

Graphs are non-linear mathematical structures that consist of pairs of sets of vertices and edges. Graph theory refers to the study of graphs, which can offer insights into the relationships between different vertices and edges between different graphs and can be used to model pairwise relations between objects. Graph theory is an integral component in many areas of modern science, including computer science, artificial engineering, machine learning, deep learning, data science, and social networks.

As data becomes more conveniently collected and stored, large amounts of unlabeled data give data scientists more data than they are capable of analyzing. Semi-supervised learning (SSL) is an approach to machine learning that involves a small amount of labeled data with a large amount of unlabeled data to achieve an accurate classification with significantly fewer training points.

Active learning is a subset of SSL that interactively queries a human agent to label a selected number of unlabeled data points with the desired outputs. Since manual labeling of these growing amounts of data can be expensive and time-consuming, active learning is becoming an appealing option to process these unlabeled data to improve the underlying SSL classifier's performance.

### SUMMARY OF INVENTION

Systems and methods for subgraph matching using active learning in accordance with embodiments of the invention are illustrated. One embodiment includes a method for subgraph matching with active learning. The method includes steps for encoding vertices of a world graph into a plurality of candidate sets, applying a first filter to each of the plurality of candidate sets to reduce the number of candidates in each of the plurality of candidate sets, querying for a template vertex in a corresponding candidate set from the plurality of candidate sets, determining a final candidate matching the corresponding template vertex for each of the plurality of the candidate sets, and returning a number of total queries made.

In a further embodiment, the each of the plurality of candidate sets of vertices correspond to a vertex of a template graph such that the vertex of the template graph can be mapped to a vertex in a candidate set.

In still another embodiment, the first filter is selected from the group consisting of Node Label Filter, Node-level Statistics Filter, Topology Filter, Repeated-Sets Filter, Neighborhood Filter, and Elimination Filter.

In a still further embodiment, the choice of the filter is task-specific.

In yet another embodiment, the querying comprises using a querying algorithm to select an optimal vertex in the template graph to query.

In a yet further embodiment, the querying comprises using external information to determine if the template vertex is matched.

In another additional embodiment, determining a final candidate comprises applying a second filter to reduce the number of candidates in the candidate set based upon the querying and external information.

In a further additional embodiment, the second filter is the same as the first filter.

In another embodiment again, the querying and applying a second filter are performed iteratively to determine the final candidate in the candidate set.

In a further embodiment again, each iteration of querying comprises adding the used external information into the querying algorithm.

In still yet another embodiment, determining a total number of subgraph isomorphisms (SIs) between the template graph and world graph.

In still another additional embodiment, the total number of SIs is determined by a spanning-tree-based estimation.

In a still further additional embodiment, the spanning-tree-based estimation comprises indexing the template vertices.

In still another embodiment again, the first filter is based on basic properties of subgraph isomorphisms.

In a yet further additional embodiment, the querying comprises selecting a querying algorithm that solves subgraph matching using the fewest number of queries.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates an example subgraph matching problem (SMP) in a multichannel setting in accordance with an embodiment of the invention.

FIG. 2 illustrates a conceptual workflow of subgraph matching using active learning in accordance with an embodiment of the invention.

FIG. 3A illustrates a process for performing subgraph matching in accordance with an embodiment of the invention.

FIG. 3B illustrates a process of adjusting template graphs based on filtering in accordance with an embodiment of the invention.

FIG. 4 illustrates a pseudocode of the subgraph matching algorithm using active learning in accordance with an embodiment of the invention.

FIG. 5 illustrates an edge entropy computation in accordance with an embodiment of the invention.

FIG. 6 illustrates a pseudocode of TreeEPM algorithm in accordance with an embodiment of the invention.

FIG. 7 illustrates a process of estimating the EPMs for the candidate of the selected vertex with label 3 in accordance with an embodiment of the invention.

FIG. 8 illustrates a computing device that can be utilized to perform subgraph matching with active learning in accordance with an embodiment of the invention.

FIG. 9 illustrates a network architecture for subgraph matching using active learning in accordance with an embodiment of the invention.

### DETAILED DESCRIPTION

Subgraph matching is one of the fundamental problems in graph theory that involves finding a smaller template graph, known as a subgraph, within a larger world graph. Subgraph matching is a common task that has applications in many fields, such as computer science, cheminformatics, biology, and social network analysis. The goal of subgraph matching is to identify patterns or structures within the template graph that are isomorphic to the world graph. Two graphs are isomorphic if there exists a bijection between their vertices and edges such that the adjacency relation is preserved. This can be useful for identifying relationships between different entities, predicting future behavior, and detecting anomalies or outliers. Graph theory provides a powerful framework for analyzing complex systems, and subgraph matching is an important tool for exploring these systems.

While the objective of the subgraph matching problem (SMP) may be straightforward, it can be computationally challenging to actually solve an SMP, especially for larger world graphs. A good subgraph matching algorithm should be exact, which means that it needs to find all isomorphic subgraphs in the world graph. Partial matches can be helpful towards locating exact matches, but the overall goal of a subgraph matching algorithm is generally to find all exact matches. However, it is computationally intensive for a subgraph matching algorithm to be exact since the number of possible subgraphs of a graph can grow exponentially with the size of the graph. The world graph may have additional vertices and edges that are equally good candidates for components of the template graph, and the template may have vertices and edges that are interchangeable, which can create confusion for the algorithm. Additionally, subgraph matching algorithms must be able to handle noise and errors in the data.

In a real-world use-case scenario, it may be necessary to identify one specific subgraph isomorphism (SI) by restricting the candidate vertices and edges in the world graph. In some cases, there may be more than one SI of relevance. These potential conditions could lead to additional constraints being imposed on the algorithm, and with more constraints added to the algorithm, the complexity of the algorithm may increase correspondingly. Therefore, to solve the SMP in a real-world application, it can be beneficial to explore strategies to reduce the complexity of the solution space with minimal cost. This can, in turn, help with simplifying the algorithm.

Active learning is an area in statistical machine learning that involves a subject matter expert (SME) participating in the actual algorithm for aiding the classification of points in a dataset. Supervised machine learning algorithms generally require an abundance of labeled data. However, in a real-world dataset, unlabeled data is common, and accurate labeling may require human involvement that cannot be crowd-sourced due to privacy or security reasons. Semi-supervised machine learning methods are therefore often superior in a real-world application, as they use significantly fewer training points. Active learning in numerous embodiments of the invention involves the use of an algorithm or formula to choose individual data points for labeling by an SME, and the newly labeled data are included back into the semi-supervised learning process. In the context of subgraph matching, active learning could simplify the sorting and matching process through the use of external information brought forth by an SME.

Current methods to perform subgraph matching do not typically involve active learning and mostly use approaches such as tree search, constraint propagation, and graph indexing. However, these methods can be very computationally intensive. For example, constraint propagation keeps a record of all vertices in the world graph that may be possible matches for each template vertex. While a combination of constraint propagation and tree search can solve the SMP, the computational load of this combination may be high. Other algorithms are approximate, meaning that they can be much faster, but there is no guarantee that they can find all isomorphic subgraphs.

Systems and methods in accordance with many embodiments of the invention can incorporate active learning into subgraph matching to reduce the number of computations required to find the matching solution set. In many embodiments, a system or process determines the optimal vertices for an SME to obtain external information using a novel querying algorithm. The SME can review the optimal vertex(s) identified by the querying algorithm and introduce any additional external information they deem to be helpful in deciding whether the vertex being reviewed is indeed an isomorphism of a vertex in the template graph. External information can include, for example, an indication that the vertex is correctly matched, adding additional one or more labels or edges to the world graph, and/or adding additional characteristics or values to one or more vertices or edges. The external information can be fed back into the subgraph matching algorithm such that the next query can be made with the external information incorporated in it. The inclusion of the external information can further filter the possible isomorphisms in the world graph, which allows the querying algorithm to be more focused on locating the correct vertices that are isomorphisms of the template graph. In numerous embodiments, the querying and filtering loop is performed iteratively until the SMP is solved and a comprehensive solution set is obtained.

### Subgraph Matching

Subgraph matching in a real-world scenario typically involves complex multichannel graphs that have vast solution spaces. A multichannel graph [symbol] =( [symbol] , [symbol] , [symbol] , [symbol] ) can be defined as a set of vertices, directed edges between the vertices, labels on the vertices, and channels on the edges. The number of vertices is denoted n. Each vertex [symbol] ∈ [symbol] has a label [symbol] ( [symbol] ) belonging to some arbitrary set of labels. There can be any number of edges between each pair of vertices (u, [symbol] ) in either direction. Each edge belongs to one of the channels [symbol] . Edges between the same pair of vertices in the same channel with the same direction are indistinguishable. The function [symbol] : [symbol] × [symbol] → [symbol] describes the number of edges in each channel between each pair of vertices. In particular, [symbol] (u, [symbol] ) can be represented as a | [symbol] |-dimensional vector, the kth element of which is the number of edges from vertex u to vertex [symbol] in the kth channel.

In a multichannel graph, two vertices are adjacent or neighboring if there is an edge between them in either direction in any channel. An edge is incident to a vertex if the vertex is one of the edge's endpoints. The degree of a vertex [symbol] can be denoted as deg( [symbol] ) in a multichannel graph as the number of edges incident to a vertex. The neighborhood of a vertex [symbol] , denoted as N( [symbol] ), is the set of all adjacent vertices. A path is a finite sequence of distinct vertices such that any two consecutive vertices are adjacent. A subgraph of a multichannel graph [symbol] =( [symbol] , [symbol] , [symbol] , [symbol] ) is a multichannel graph [symbol] =( [symbol] , [symbol] ′, [symbol] , [symbol] ) with [symbol] ⊂ [symbol] , [symbol] , [symbol] ( [symbol] )= [symbol] ( [symbol] ) for all [symbol] ∈ [symbol] , and [symbol] (u, [symbol] )≤ [symbol] (u, [symbol] ) for all u, [symbol] ∈ [symbol] .

The SMP can be succinctly stated: given two multichannel networks, a template graph [symbol] =( [symbol] , [symbol] , [symbol] , [symbol] ) and a world graph [symbol] =( [symbol] , [symbol] , [symbol] , [symbol] ), we wish to find all subgraphs of the world graph that match the template graph. For the subgraphs of the world graph to match the template graph means that the subgraphs are isomorphisms of the template graph. An injective function ƒ: [symbol] → [symbol] is called a SI or subgraph matching from [symbol] =( [symbol] , [symbol] , [symbol] , [symbol] ) to [symbol] =( [symbol] , [symbol] , [symbol] . [symbol] ) if

$$\begin{matrix}{ℒ}_{t} ( υ ) = {ℒ}_{w} ( f ( υ ) ) & ∀ υ ∈ {𝒱}_{t}\end{matrix} \qquad ( 1 )$$

$$\begin{matrix}{ℰ}_{r} ( u , υ ) \leq {ℰ}_{w} ( f ( u ) , f ( υ ) ) & ∀ u , υ ∈ {𝒱}_{t} * {𝒱}_{t}\end{matrix} \qquad ( 2 )$$

and the set of all SIs from [symbol] to [symbol] is denoted [symbol] ( [symbol] , [symbol] ). This definition can be used to define isomorphisms in which the world graph has more edges than the template. If the function additionally satisfies (2) at equality, it is an induced SI. A function which satisfies (1) and (2) but is not necessarily injective is an edge-preserving map (EPM).

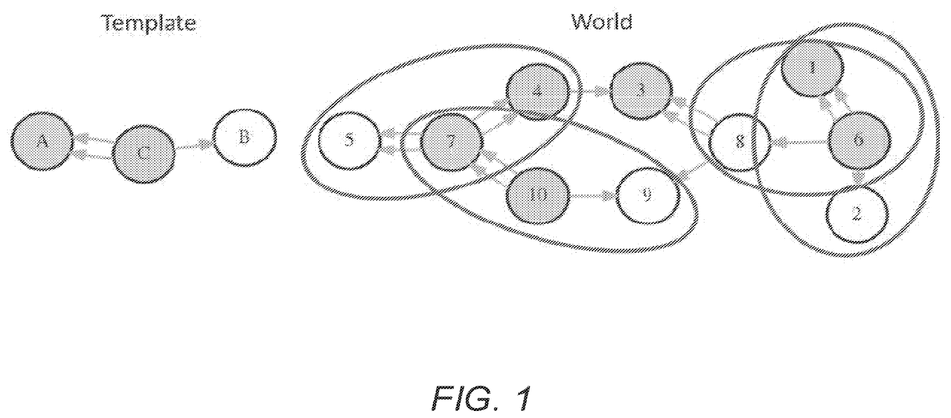

FIG. 1 illustrates an example SMP in a multichannel setting in accordance with an embodiment of the invention. Solving the SMP illustrated in FIG. 1 would require the algorithm to locate all the combinations of vertices and edges in the world graph that are isomorphisms of the template graph. Even in an SMP of a smaller scale illustrated in FIG. 1, there are four SIs corresponding to mapping the template vertices (A, C, B) to each of the four circled sets of vertices (4, 7, 5), (7, 10, 9), (1, 6, 8), (1, 6, 2). With subgraph problems involving larger multichannel graphs, the potential number of solutions may increase even further. Hence, integrating active learning into the SMP stems from a desire to increase matching accuracy and reduce computational load when using subgraph matching in a real-world application.

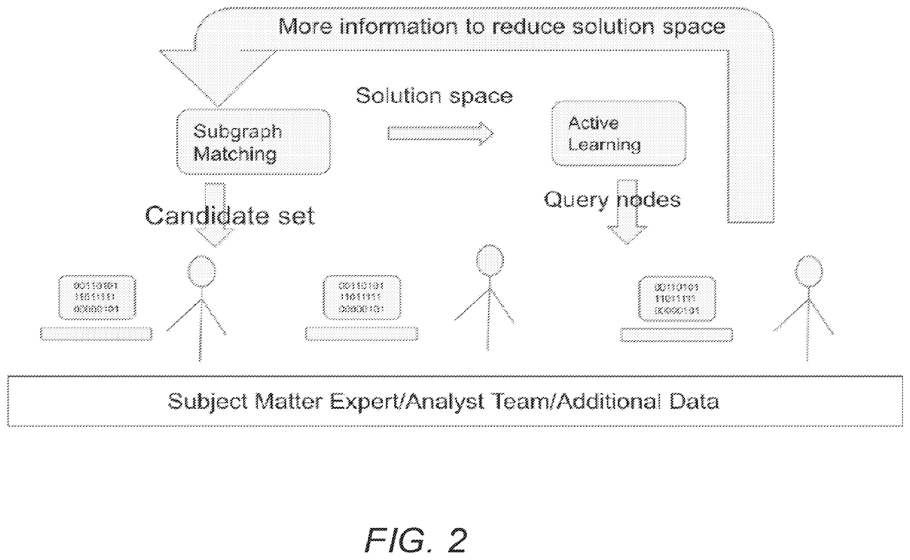

A conceptual workflow of subgraph matching using active learning in accordance with an embodiment of the invention is illustrated in FIG. 2. In many embodiments; the system obtains candidate sets for all template vertices using a filter-based subgraph matching algorithm. An active learning algorithm can be used to determine one or more optimal vertices for an SME to review. The SME can review the suggested vertices using external information they deem to be helpful in classifying the suggested vertices. The SME's decision and the external information used by the SME to make the decision can be fed back into the subgraph matching algorithm to further filter the candidate sets.

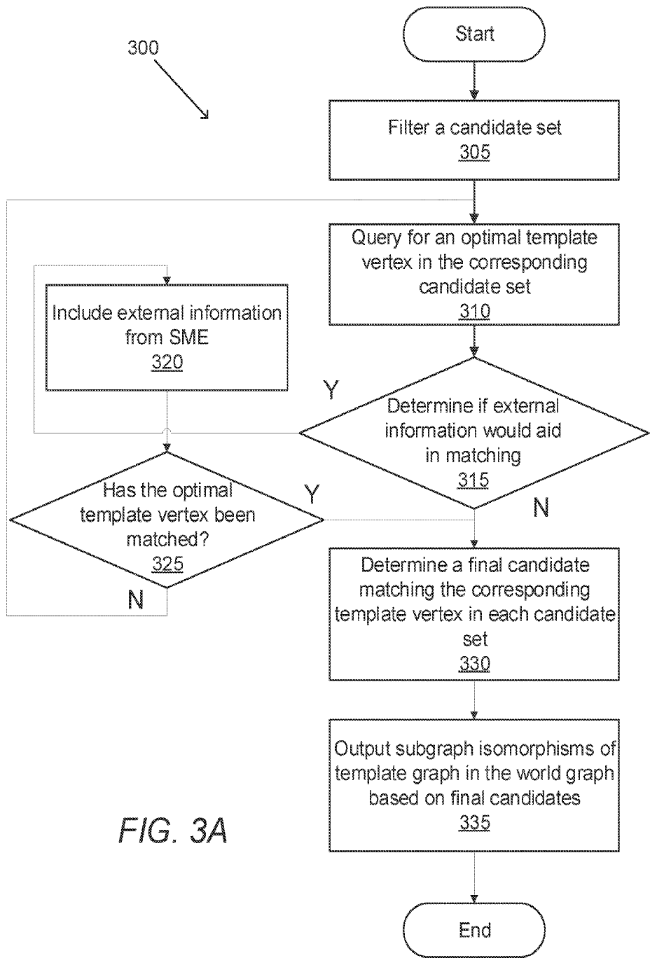

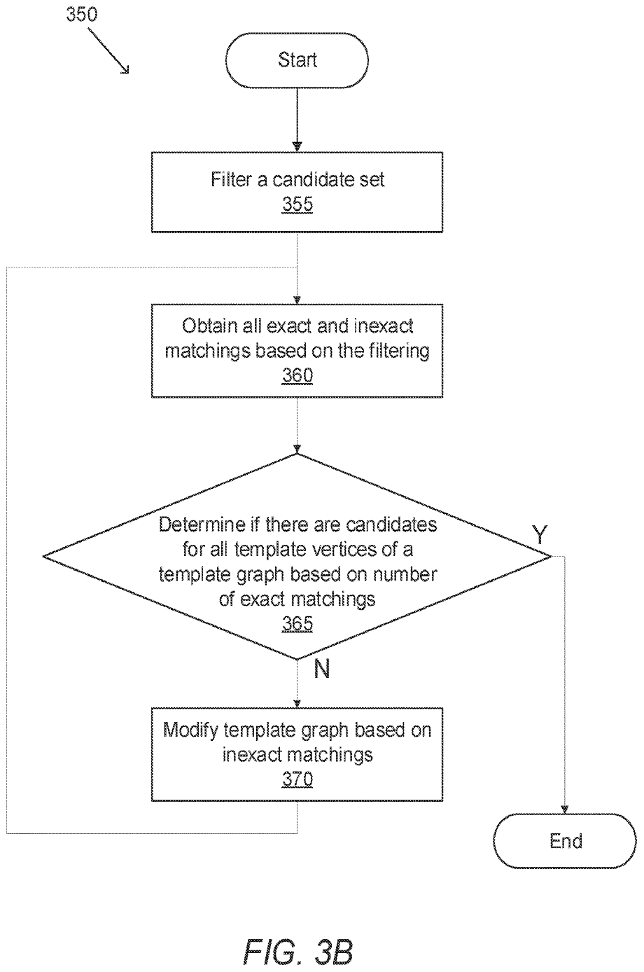

FIG. 3A illustrates a process for performing subgraph matching in accordance with an embodiment of the invention. In several embodiments, vertices of world graphs are first encoded into a plurality of candidate sets. In many embodiments, candidate sets are sets of world vertices to which a given template vertex t∈ [symbol] may be mapped. In several embodiments, a template vertex is isomorphic to a world vertex if the template vertex can be mapped onto the world vertex. A candidate set for template vertex t may be denoted by C(t) and excludes any world vertex that has been ruled out as a candidate for t.

Process 300 filters (305) a candidate set. Filtering is the process of ruling out candidates. In many embodiments, filtering is performed using basic properties of SIs known to be true. Examples of these basic properties can include, but are not limited to, that template vertices must map to vertices of higher degree and that neighboring template vertices map to neighboring world vertices. Various techniques for filtering that may be utilized in accordance with embodiments of the invention are be further discussed below.

In many embodiments, the filtering may produce exact and inexact matches. If the filtering does not produce any exact matches, this can mean that there are not candidates for all template vertices in the template graph. Adjustments can be made to the template graph to locate exact matches. This adjustment process will be discussed in further detail below.

Once there are candidates for all template vertices, process 300 queries (310) for an optimal template vertex in the corresponding candidate set. Template vertex may be a vertex from a template graph. In many embodiments, the optimal template vertex may be identified by querying algorithms discussed further below. In numerous embodiments, querying involves an algorithm that selects an optimal template vertex to query. External information from SMEs may be introduced in this step to incorporate the active learning process, as the system can seek external information to determine the assignment of the selected template vertex in the world graph. In many embodiments, the querying algorithm can further filter the candidate set based on the previous querying result and the external information introduced.

Process 300 determines (315) if external information by an SME would aid in matching based on the results of the query. If external information is necessary, process 300 can include (320) external information provided by an SME. External information provided by an SME can be included into the next query. Process 300 checks (325) whether the optimal template vertex has been matched. In numerous embodiments, external information can take the form of labels where the SME can help decide whether the queried vertex does indeed match with the candidate in the world graph. If there are no matches, process 300 can return to 310 to query for the optimal template vertex in other candidates in the candidate set.

If systems determine that external information is not necessary, process 300 determines (330) a final candidate matching the corresponding template vertex in each candidate set. In numerous embodiments, querying may be an iterative process where systems can query and filter the candidate sets of each template vertex alternately until there is only one candidate left in the set. Once filtering and querying have reduced the size of the candidate sets of each template vertex to one candidate, the matching has been determined. Process 300 outputs (335) subgraph isomorphisms of a template graph in the world graph based on the final candidates. In several embodiments, systems can return the number of total queries made to output the subgraph isomorphisms.

While specific processes for subgraph matching using active learning are described above, any of a variety of processes can be utilized to perform subgraph matching using active learning as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

FIG. 3B illustrates a process of adjusting template graphs based on filtering in accordance with an embodiment of the invention. Process 350 filters (355) a candidate set. Process 350 obtains (360) all exact and inexact matchings based on the filtering. The concept for inexact matches can be found in T. K. Tu, J. D. Moorman, D. Yang, Q. Chen, A. L. Bertozzi, “Inexact Attributed Subgraph Matching,” 2020 IEEE International Conference on Big Data, pp. 2575-2582, 2020, the relevant disclosure of which is hereby incorporated by reference in its entirety.

Process 350 can determine (365) if there are candidates for all template vertices of a template graph based on number of exact matchings. In many embodiments, if there are no exact matchings, then there are no candidates for all template vertices. Process 350 can modify (370) the template graph based on the inexact matchings. In many embodiments, modifications can be made to the template graph to broaden the search. In several embodiments, there may be inexact matches based on the filtering, and template graphs can be modified based on the information presented by the inexact matches.

While specific processes for adjusting template graphs based on filtering are described above, any of a variety of processes can be utilized to adjust template graphs as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

In many embodiments, filtering is a key tool to narrow down candidate sets to solve the subgraph matching problem. One example filter is a node label filter. The node label filter requires that in order for a world vertex [symbol] to be a candidate for a template vertex [symbol] , the label [symbol] ( [symbol] ) must match the label [symbol] ( [symbol] ).

Node-level statistics filter can also be an option for filtering, which provides that for a world vertex [symbol] to be a candidate for a template vertex [symbol] , certain statistical properties of [symbol] should not be less than those of [symbol] .

A topology filter can also be used as a filter, where the topology filter enforces the constraint that if [symbol] is a candidate for template vertex [symbol] , then for every template vertex uₜ neighboring [symbol] , there must exist a candidate u_{w} for uₜ that neighbors [symbol] . The natural extension to multiplex networks is that if [symbol] is a candidate for template vertex [symbol] then for every template vertex uₜ neighboring [symbol] , there must exist a candidate u_{w} for uₜ that has as many edges in each channel and direction between [symbol] and u_{w} as there are between [symbol] and uₜ.

Repeated-sets filter may be another option, which provides that for a world vertex [symbol] to be a candidate for template vertex [symbol] , there must exist some injective mapping from the template vertices to their candidates under which [symbol] is mapped to [symbol] . Repeated set filter may be known as the “all-different” filter. To enforce the repeated-sets filter, we identify sets of template vertices [symbol] ⊆ [symbol] where the union of their candidates [symbol] D( [symbol] ) has the same cardinality as [symbol] . These are known as tight sets. Candidates for template vertices in a tight set cannot be candidates for any vertices outside of the tight set, since this would violate Repeated-sets filter.

Another option can be the neighborhood filter, which extends the local all-different constraint to the multiplex network case. In the undirected single-layer graph context, the local all-different constraint provides for a world vertex [symbol] to be a candidate for a template vertex [symbol] , there must be some injective mapping ƒₗ from the neighbors of [symbol] to their candidates under which ƒₗ(uₜ) is a neighbor of [symbol] for each uₜ.

Elimination filter can also be an option, which filters by identifying any contradictions that would result from them being assigned. For each template vertex-candidate pair ( [symbol] , [symbol] ), [symbol] may be assigned to [symbol] and iterate over all other filters until convergence. If this results in one or more template vertices having no candidates, then [symbol] cannot be mapped to [symbol] and we eliminate [symbol] as a candidate for [symbol] .

In numerous embodiments, systems can alternately filter the candidate sets of each template vertex based on a combination of at least one filter described above. The choice of a filter to use to eliminate candidates can be task-specific. Example choices of a filter are discussed in J. D. Moorman, T. K. Tu, Q. Chen, X. He, A. L. Bertozzi, “Subgraph Matching on Multiplex Networks,” IEEE Transactions on Network Science and Engineering, vol. 8, no. 2, pp. 1367-1384, 1 Apr.-Jun. 2021, the relevant disclosure of which is hereby incorporated by reference in its entirety.

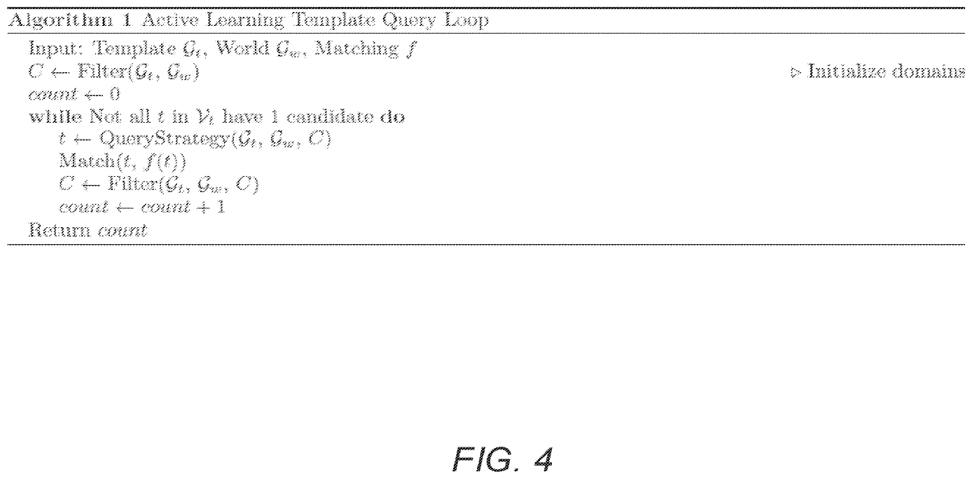

FIG. 4 illustrates a pseudocode of a subgraph matching algorithm using active learning in accordance with an embodiment of the invention.

### Querying and Active Learning

The purpose of incorporating active learning into subgraph matching is so that the querying can be more pointed and direct. When the querying is highly effective, more information can be imparted into the learning process of the algorithm. The algorithm itself is able to filter out vertices from candidate sets more effectively and efficiently with more information. As more iterations of the matching process are performed, the algorithm may become increasingly effective.

There are various querying strategies incorporating active learning that can be used for the subgraph matching process, e.g., in processes such as those described above. In some embodiments, the system utilizes local template centrality-based strategies to query for the isomorphisms of the template vertices in the world graph. Assume that querying a template vertex can reduce the candidate set on neighboring vertices more than other vertices; the local template centrality-based strategies are based on the local regions containing neighbors of template vertices and prefer vertices with higher degrees. Local template centrality-based strategies can be effective in reducing the solution space with a limited number of queries. An example of a local template centrality-based strategy to reduce the solution space is the maximum degree strategy, where the system chooses the template vertex with the highest degree:

$$t = arg {max}_{t ∈ {𝒱}_{t}} deg ( t ) \qquad ( 3 )$$

In some embodiments, the max sum of candidates strategy may be used, where the vertex with the largest sum of the number of candidates for neighboring template vertices and itself is chosen:

$$t = arg {max}_{t ∈ {𝒱}_{t}} ( \vert C ( t ) \vert + {\sum }_{{t}^{′} ∈ N ( t )} \vert C ( {t}^{′} ) \vert ) \qquad ( 4 )$$

In selected embodiments, the edge entropy strategy may be used to determine which template vertex to query:

$$EE ( v ) = {\sum }_{{t}^{′} ∈ 𝒩} {\sum }_{w ∈ C ( t )} - {P}_{{t}^{′}}^{EE} ( t = w ) log - {P}_{{t}^{′}}^{EE} ( t = w ) \qquad ( 5 )$$

Assuming that t∈ [symbol] , t′∈N(t),

$${N}_{{t}^{′}}^{tw}$$

is the number of candidates for t′ if t is matched to w∈C(t), and

$${N}_{{t}^{′}}^{t} = {\sum }_{w ∈ C ( t )} {N}_{{t}^{′}}^{tw} . {P}_{{t}^{′}}^{EE} ( t = w ) := {N}_{{t}^{′}}^{tw} / {N}_{{t}^{′}}^{t}$$

can be an estimate for the probability that t is mapped to w based on the possible mappings of the edge with endpoints t′ and t.

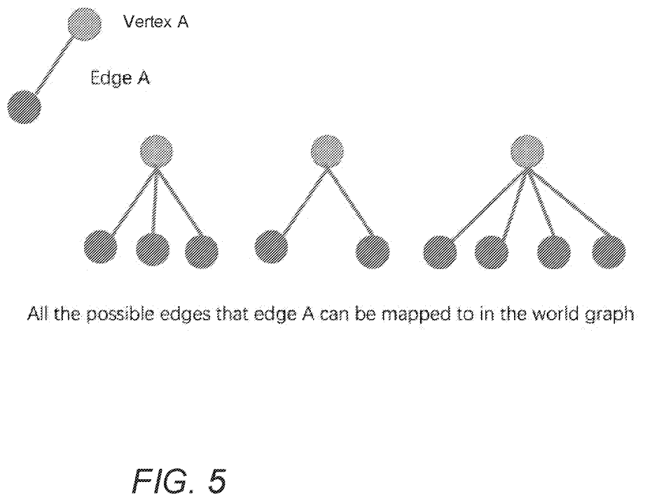

FIG. 5 illustrates an edge entropy computation in accordance with an embodiment of the invention. Edge A may be mapped to nine possible candidate edges in the world, represented by the three cases that edge A can map to. In the left scenario, there are three edges connected to the selected world vertex. Therefore, the probability in this case is ⅓. Similarly, the probability for the remaining edges are 2/9 and 4/9. Hence, the edge entropy of this edge is

$$- ( \frac{1}{3} log ( \frac{1}{3} ) + \frac{2}{9} log ( \frac{2}{9} ) + \frac{4}{9} log ( \frac{4}{9} ) ) .$$

Probabilistic query strategies can be a separate branch of strategies that may be used to query for template vertices. Probabilistic query strategies attempt to estimate the probability with which a template vertex is assigned to a given world vertex. In many embodiments, probabilistic query strategies involve granting all SIs between a given template graph and a world graph equal probabilities. The probability that a template vertex t∈ [symbol] and world vertex w∈ [symbol] are paired together is simply the proportion of SIs where they are matched:

$${P}_{SI} ( t = w ) = \frac{\vert \{ f ∈ ℱ ( {𝒢}_{t} , {𝒢}_{w} ) : f ( t ) = w \} \vert}{\vert ℱ ( {𝒢}_{t} , {𝒢}_{w} ) \vert} \qquad ( 6 )$$

If the assignment of certain template vertices to world vertices is already known, the above definition can be adjusted to restrict [symbol] ( [symbol] , [symbol] ) to those with the known assignments.

In many cases, directly computing all SIs may be computationally intractable due to the NP-complete nature of simply finding one. Instead of fully enumerating all SIs, the quantities can be approximated based on local structures. An example structure that can be used to approximate SIs is the immediate neighborhood. An approximation for the number of solutions can be obtained by asking how many mappings there are from the neighbors of a template vertex t to the neighbors of a world vertex w. In other words, the set of local SIs (LSI) for any template vertex, world vertex pair (t, w) can be defined in the following manner:

$$LSI ( {𝒢}_{t} , {𝒢}_{w} , t , w , C ) = \{ f : N ( t ) \to N ( w ) : f injective , f ( {t}^{′} ) ∈ C ( {t}^{′} ) , ∀ {t}^{′} ∈ N ( t ) \} \qquad ( 7 )$$

This is the set of SIs from the neighborhood of t to the neighborhood of w with the additional requirement that each template vertex has candidates inherited from the original SI problem. An associated probability can be defined by:

$${P}_{SI} ( t = w ) = \frac{\vert LSI ( {𝒢}_{t} , {𝒢}_{w} , t , w , C ) \vert}{{\sum }_{{w}^{′} ∈ C ( t )} \vert LSI ( {𝒢}_{t} , {𝒢}_{w} , t , {w}^{′} , C ) \vert} \qquad ( 8 )$$

Computing the number of LSIs corresponds to counting mappings between N(t) and N(w) and ensuring that each template vertex is assigned a different world vertex. In the constraint programming framework, this is referred to as an all-different problem. This problem can be reduced to that of finding the permanent of a 0-1 matrix, which lies in the P#-complete complexity class, suggesting that even this problem may be difficult to solve efficiently. In practice, the problem sizes are often small enough, and the symmetry in the candidate sets can be utilized to solve these relatively quickly.

In the case that this problem is still too costly to solve, a crude approximation to the number of LSIs may be computed by removing the injectivity requirement where the number of local edge preserving mappings (LEPM) are counted. This quantity is very easy to count as it is just given by the product of the sizes of each of the candidate sets for all neighbors:

$$LEPM ( {𝒢}_{t} , {𝒢}_{w} , t , w , C ) = {\prod }_{{t}^{′} ∈ N ( t )} \vert C ( {t}^{′} ) ⋂ N ( w ) \vert \qquad ( 9 )$$

The associated probability can be defined as:

$${P}_{LEPM} ( t = w ) = \frac{\vert LEPM ( {𝒢}_{t} , {𝒢}_{w} , t , w , C ) \vert}{{\sum }_{{w}^{′} ∈ C ( t )} \vert LEPM ( {𝒢}_{t} , {𝒢}_{w} , t , {w}^{′} , C ) \vert} \qquad ( 10 )$$

A rough approximation of the number of SIs can also be obtained by instead considering EPMs for a spanning tree of the template. The number of EPMs between a spanning tree T of template [symbol] and world [symbol] , where t is mapped to w by STEPM( [symbol] , [symbol] , t, w, T). An associated probability can be computed in the same manner:

$${P}_{STEPM} ( t = w ) = \frac{\vert STEPM ( {𝒢}_{t} , {𝒢}_{w} , t , w , T ) \vert}{{\sum }_{{w}^{′} ∈ C ( t )} \vert STEPM ( {𝒢}_{t} , {𝒢}_{w} , t , w , T ) \vert} \qquad ( 11 )$$

A variety of strategies for selecting query vertices can be designed after computing the associated probabilities. Examples of strategies in active learning for determining queries include minimum confidence sampling, margin sampling, and maximum entropy sampling. Minimum confidence sampling refers to selecting the template vertex that is least confident about its most likely assignment, which can be defined as:

$$t = arg {min}_{t ∈ {V}_{T}} {max}_{w ∈ C ( t )} P ( t = w ) \qquad ( 12 )$$

Margin sampling refers to selecting the template vertex whose two most probable assignments are closest together in probability. If

$${w}^{*} = arg {max}_{w ∈ C ( t )} P ( t = w ) ,$$

then this is given by:

$$t = arg {min}_{t ∈ {V}_{T}} ( P ( t = {w}^{*} ) - {max}_{w ∈ C ( t ) , w \neq {w}^{*}} P ( t = w ) ) \qquad ( 13 )$$

Maximum entropy sampling selects the template vertex which maximizes entropy:

$$t = arg {max}_{t ∈ {V}_{T}} - {\sum }_{w ∈ C ( t )} P ( t = w ) log P ( t = w ) \qquad ( 14 )$$

In some embodiments, a query strategy can be determined by analyzing the symmetry apparent in the subgraph matching problem. Symmetry is well-known for confounding general combinatorial problems by dramatically expanding the solution space. Algorithms that exploit symmetry can significantly reduce search time, sometimes by an exponential factor, for highly symmetric problems. These algorithms generally identify vertices that are effectively interchangeable in that exchanging them in a SI will produce another valid isomorphism.

There are various notions of symmetry that can be discussed in the context of the subgraph matching problem. One example is structural equivalence, where two vertices are deemed to be structurally equivalent when they have the exact same set of neighbors (excluding each other). These vertices can be interchanged in any isomorphism, and the new mapping will also be an isomorphism. In many embodiments, venn diagram representations can be used to represent intermediate solutions in intersections of candidate sets. The concept of structural equivalence in subgraph matching can be found in D. Yang, Y. Ge, T. Nguyen, D, Molitor, J. D. Moorman, A. L. Bertozzi, “Structural Equivalence in Subgraph Matching,” IEEE Transactions on Network Science and Engineering, vol. 10, no. 4, pp. 1846-1862, 1 Jul.-Aug. 2023, the relevant disclosure of which is hereby incorporated by reference in its entirety. A more complicated notion which includes structural equivalence is automorphic equivalence. Two vertices are automorphically equivalent if there is an automorphism φ: [symbol] →V on the graph mapping one vertex to the other. Then, given this automorphism φ and any SI f, we can construct a new SI ƒ∘φ.

In the context of the active learning problem, symmetry can be an important factor to consider when deciding which vertices to query. In a group of M structurally equivalent template vertices, for any SI f, M!−1, additional isomorphisms can be constructed by simply permuting the images of these vertices. All of these isomorphisms may be valid based on the information apparent in the problem. Discerning which permutation is the true solution necessarily requires querying at least M−1 of these vertices (the last may be determined by the process of elimination). In an example satisfiable SI problem with template [symbol] =( [symbol] , [symbol] ) and world [symbol] =( [symbol] , [symbol] ), where

$${v}_{t} = {⋃}_{i = 1}^{N} {S}_{i}$$

partitions the template vertices into structural equivalence classes, then at least

$${\sum }_{i = 1}^{N} ( \vert {S}_{i} \vert - 1 )$$

template queries are needed to identify a unique solution.

Discerning between isomorphisms that are generated by applying an automorphism to the template graph can be more challenging. Relevant to this task is the notion of a base of the automorphism group of a template graph. A base of an automorphism group is a sequence of vertices (v₁, v₂, . . . , vₙ) such that for any pair of automorphisms φ₁≠φ₂, the two sequences (φ₁( [symbol] ₁), φ₁( [symbol] ₂), . . . , φ₁( [symbol] ₙ)), and (φ₂( [symbol] ₁), φ₂( [symbol] ₂), . . . , are φ₂( [symbol] ₙ)) are distinct. This definition implies that the values of φ on v₁, . . . , vₙ can uniquely identify φ. Hence, distinguishing isomorphisms generated by the automorphism group can involve querying all vertices of a base of the automorphism group.

### Spanning-Tree-Based Estimation of SI Count

For larger multichannel graphs with long paths, a spanning tree-based estimation can be more computationally tractable. In some embodiments, the spanning tree-based estimation method is based on the estimation method set forth in the CFL-Match algorithm, which proposed a new data structure called the compact path index (CPI). CPI can be defined by the rule: there is an edge between [symbol] ∈C(u) and [symbol] ∈C(u₀) for adjacent vertices u and u₀ in CPI if and only if [symbol] ( [symbol] , [symbol] ₀)=1 in G. The data structure can be used to estimate the frequency of solutions when the template is a path graph and can be extended to the case when the template is a tree. In such a case, the estimation is the number of edge-preserving mappings generated by the current candidate list. For a more general template, a breadth first search (BFS) starting from the selected vertex can be used to generate a spanning tree of the template and perform the estimation using the spanning tree.

In certain embodiments, the number of possible edge-preserving mappings to the current candidate set can be used to approximate the number of SIs. By removing the injectivity constraint, the system may bypass the all-different problem and complete the estimation in polynomial time.

A graph T can be called a path graph if there exists an indexing of template vertices [symbol] ={x₁, x₂, . . . , xₖ} such that the edge set of the template satisfies the following conditions: [symbol] (xᵢ, xⱼ)>0⇔(xᵢ, xⱼ)∈{(x₁, x₂), . . . , (xₖ₋₁, xₖ), were xₖ is defined as the root of the path graph. If xₖ is the root of the path graph template, then the template vertices can be indexed by x₁, x₂, . . . , xₖ such that edges only exist in vertices with consecutive indices. If the template is a path graph with a root xₖ, the solution frequency estimation problem with a given vertex xₖ is called the path graph root estimation problem.

In a template graph t where xx is a given vertex of t, and where C(xⱼ)[j] represents the j^{th} element in the candidate set C(xᵢ), the solution frequency estimation problem can approximate the cardinality of the following sets of SI solutions ƒ:{ƒ∈ [symbol] ( [symbol] , [symbol] )|ƒ(xₖ)=C(xₖ)[j]} for j=1, 2, . . . , |C(xₖ)|. The CPI adjacency matrix M_{i,i+1} is a 0-1 matrix of size |C(xᵢ)|×|C(xᵢ₊₁)|, where if [symbol] (C(xᵢ)[a], C(xᵢ₊₁)[b])>0, then M_{i,i+1}[a, b]=1. Otherwise, M_{i,i+1}[a, b]=0. The CPI graph can then be defined as a single-channel graph with

$${\sum }_{i = 1}^{k} \vert C ( {x}_{i} ) \vert$$

vertices. The vertices can be indexed by the following set: [symbol] ={(xᵢ, C(xᵢ)[j]), i=1, 2, . . . , k; j=1, 2, . . . , |C(xᵢ)|}. This means that each vertex corresponds to a unique template-candidate pair. The edge set is defined to be:

$$ℰ ( ( {x}_{i} , C ( {x}_{i} ) [ a ] ) , ( {x}_{j} , C ( {x}_{j} ) [ b ] ) ) = 1 ⇔ \vert j - i \vert = 1 and$$

$${ℰ}_{w} ( C ( {x}_{i} ) [ a ] , C ( {x}_{i + 1} ) [ b ] ) \geq {ℰ}_{t} ( {x}_{i} , {x}_{j} )$$

### Otherwise,

$$ℰ ( ( {x}_{i} , C ( {x}_{i} ) [ a ] ) , ( {x}_{j} , C ( {x}_{j} ) [ b ] ) ) = 0 .$$

This means the edges of the CPI graph contain all the template-candidate pairs such that the template vertex and candidate are simultaneously neighboring to each other. In the setting of the path graph template root estimation problem, the exact number of edge-preserving mappings for path graph templates can be calculated by calculating the cardinality of edge-preserving mappings:

$$\vert \{ g ∈ EPM \vert g ( {x}_{k} ) = C ( {x}_{k} ) [ j ] \} \vert = ( {1}^{T} \cdot {\prod }_{i = 1}^{k - 1} {M}_{i , i + 1} ) [ j ] \qquad ( 15 )$$

In many embodiments, the definition of a tree in graph theory can be extended to multichannel graphs to determine the SI count. A tree in graph theory is defined for single-channel graphs as a connected acyclic undirected graph. A tree is also a notion in data structure usually visualized by a tree in the context of graph theory and stores the connection and hierarchy of the vertices. These two definitions of a tree are linked together by assigning a root to the tree. For a directed or undirected multichannel graph G, the underlying graph G^{u} is a single channel, undirected simple graph which can be defined as:

$${𝒱}_{G} = {𝒱}_{{G}^{u}}$$

$$( x , y ) ∈ {ℰ}_{{G}^{ι ι}} ⇔ {ℰ}_{G} ( x , y ) > 0 or {ℰ}_{G} ( y , x ) > 0$$

A multichannel graph G has a tree structure if and only if the underlying graph G^{u} is a tree. If G is a tree or G is a multichannel graph with tree structure and u∈ [symbol] , then the pair (G, u) is called a rooted tree with root u. For a rooted tree (T, r), where w is any vertex other than r. If G is a tree, then there is a unique path P in G that connects w and r. If G has a tree structure, then there is a unique path P in G^{u} that connects w and r. If P=( [symbol] , [symbol] , [symbol] , . . . , [symbol] ), where [symbol] =r, [symbol] =w. Then [symbol] ₖ₋₁ is called the parent of w, and w is called the child of [symbol] . [symbol] , [symbol] , [symbol] , . . . , [symbol] are called the ancestors of w, and w is the descendant of [symbol] , [symbol] , [symbol] , . . . , [symbol] . Vertices with the same parent are called siblings to each other. If (T, r) is a rooted tree, and w∈ [symbol] . The subgraph T_{w} generated by w and all its descendants also has a tree structure. (T_{w}, w) is called the subtree of (T, r) with root w.

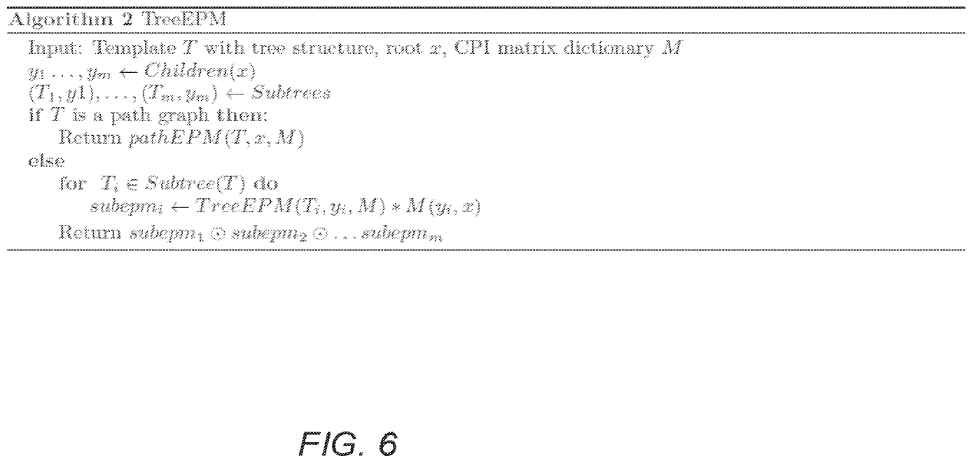

Equation (15) may be denoted as pathEPM and uses the following divide and conquer algorithm denoted TreeEPM to calculate the number of EPMs. FIG. 6 illustrates a pseudocode of the TreeEPM algorithm in accordance with an embodiment of the invention. In many embodiments, the CPI matrices are precalculated and stored in a hash map M to avoid repeat calculations. The CPI matrix for template vertices x and y may be denoted as M (x, y). As illustrated in FIG. 6, ⊙ denotes the element-wise product of two vectors. TreeEPM can return the exact number of EPMs regarding each candidate vertex of the selected root x. The cardinality of edge-preserving mappings can be computed by |{g∈EPM(T)|g(x)=C(x)[j]}|=TreeEPM(T, x, M)[j].

A general template does not naturally generate a tree structure. Therefore, to extend the spanning tree method to a general template, in many embodiments, a breadth first search is utilized to produce a spanning tree of the template. The number of EPMs on the general template can be estimated by TreeEPM.

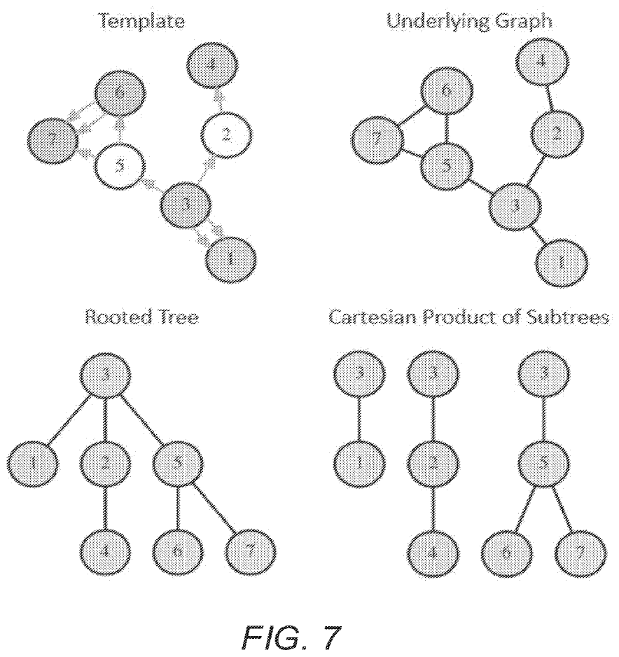

Then, we give the following estimation algorithm for a general template. For a selected vertex x, the TreeEPM algorithm can be used on the rooted tree structure with root x. The algorithm can return a vector of |C(x)| length, recording an estimate of the number of EPMs that map x to each element in C(x). FIG. 7 illustrates a process of estimating the EPMs for the candidate of the selected vertex with label 3 in accordance with an embodiment of the invention. The underlying graph of the template is shown on the top right of FIG. 7. By using the BFS starting from vertex 3, a rooted tree with parent/children relations shown in the bottom left of FIG. 7 can be obtained. By looking at the subtrees, the estimation can be calculated by the Cartesian product of the estimation from three subproblems with smaller sizes.

In many embodiments, the complexity analysis of the algorithm has three steps, including the calculation of CPI matrix hash map M, the multiplication of matrices in the path, and the Cartesian product constructed in the tree structure | [symbol] |, | [symbol] |,

$$\vert {ℰ}_{w}^{u} \vert , \vert {ℰ}_{t}^{u} \vert$$

denote the number of edges in the template, world, and underlying graphs of the template and world graphs, respectively. C^{max} denotes the maximal size of a candidate set C(x).

$${D}_{t}^{max}$$

denotes the maximal degree of the template graph, and

$${D}_{u}^{aνg}$$

denotes the average degree of the underlying graph of the world graph.

In many embodiments, an upper bound for the worst-case complexity is computed for the complexity analysis. A CPI matrix for all the adjacent pairs of vertices in the template can be computed such that the number of CPI matrices to compute is equal to Nₑᵤₜ, and the size of each CPI matrix is C^{max}×C^{max}. The complexity of this part may be bounded by

$$O ( \vert {ℰ}_{t}^{u} \vert {( {C}^{max} )}^{2} ) .$$

If a vertex x has been selected to construct the tree, all vertices in the template need to be reviewed. Therefore, the complexity of this part is bounded O(| [symbol] |).

Then, the matrix of every edge in the BFS tree needs to be multiplied where the number of edges is equal to | [symbol] |−1. For each vertex in the BFS tree, the size of the Cartesian product is bounded by | [symbol] |−1, and the cost of computing each Cartesian product is bounded by O(C^{max}). The total cost of this step is bounded by O((C^{max})³| [symbol] |)+O(C^{max}*| [symbol] |)=O((C^{max})³| [symbol] |).

All vertices need to be selected to repeat the calculation, and the total time complexity of the algorithm is bounded by

$$O ( {( {C}^{max} )}^{3} {\vert {𝒱}_{t} \vert}^{2} + \vert {ℰ}_{t}^{u} \vert ( {( {C}^{max} )}^{2} ) .$$

This expression demonstrates that the algorithm can be completed within polynomial time. However, this bound of time complexity can be larger if the number of candidates for any vertex is large. In certain embodiments, the template and the world graph are both sparse.

$$\vert {ℰ}_{t}^{u} \vert = O ( \vert {𝒱}_{t} \vert )$$

may be assumed from the sparsity of the template. In many embodiments, from the sparsity of the world graph, the expectation of a number of nonzero elements of each column of the CPI matrix is equal to

$${D}_{u}^{avg} .$$

Therefore, the complexity of matrix multiplications for a BFS tree will be

$$O ( {( {C}^{max} )}^{2} \vert {𝒱}_{t} \vert {D}_{u}^{avg} )$$

instead of O(C^{max})³| [symbol] |). Hence, in several embodiments, the expectation of total complexity with the assumption of sparsity is

$$O ( {( {C}^{max} )}^{2} {\vert {𝒱}_{t} \vert}^{2} {D}_{u}^{avg} ) .$$

### System Implementation

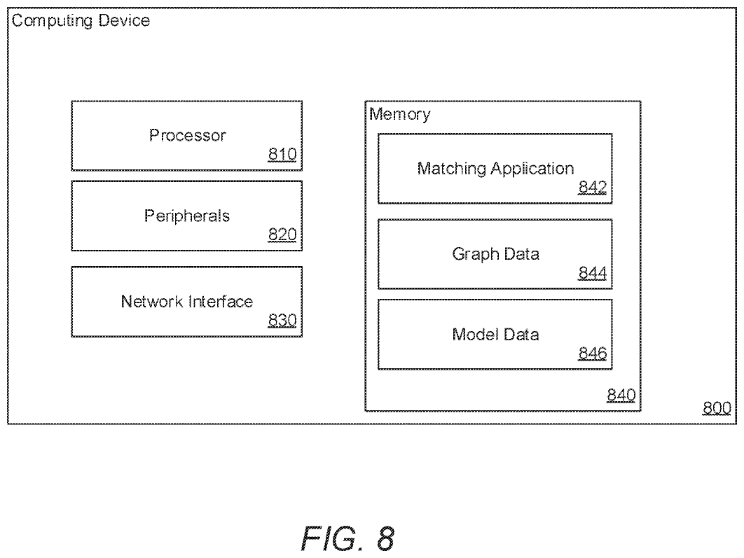

Processes that provide the methods and systems for performing subgraph matching with active learning in accordance with some embodiments can be executed by a computing device or computing system, such as a desktop computer, tablet, mobile device, laptop computer, notebook computer, server system, and/or any other device capable of performing one or more features, functions, methods, and/or steps as described herein. FIG. 8 illustrates a computing device that can be utilized to perform subgraph matching with active learning in accordance with an embodiment of the invention. Computing device 800 includes a processor 810. Processor 810 may direct the matching application 842 to perform subgraph matching with active learning based on graph data 844 and model data 846. In many embodiments, processor 810 can include a processor, a microprocessor, a controller, or a combination of processors, microprocessor, and/or controllers that performs instructions stored in the memory 840 to perform subgraph matching. Processor instructions can configure the processor 810 to perform processes in accordance with certain embodiments of the invention. In various embodiments, processor instructions can be stored on a non-transitory machine readable medium. Computing device 800 further includes a network interface 820 that can receive graph data from external sources. Computing device 800 may further include a memory 840 to store learning models under model data 846. Computing device 800 may further include peripherals 820 to allow for user control and analysis of the matching process.

Although a specific example of a computing device is illustrated in this figure, any of a variety of transmitting elements can be utilized to perform subgraph matching similar to those described herein as appropriate to the requirements of specific applications in accordance with embodiments of the invention.

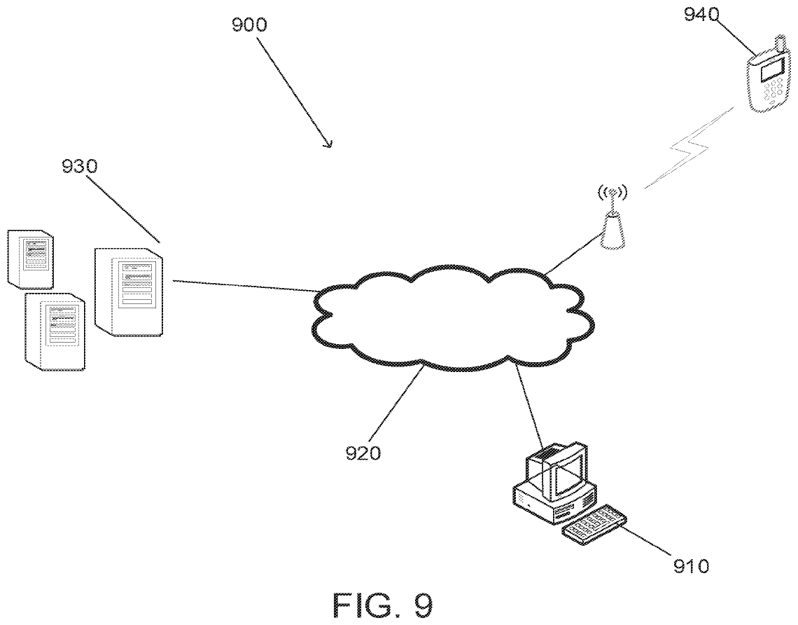

FIG. 9 illustrates a network architecture for subgraph matching using active learning in accordance with an embodiment of the invention. Such embodiments may be useful where computing power is not possible at a local level, and a central computing device (e.g., server) performs one or more features, functions, methods, and/or steps described herein. In such embodiments, a computing device 910 (e.g., personal computer) is connected to a network 920 (wired and/or wireless), where it can receive inputs from one or more computing devices, including data from a records database or repository 930 containing graph data to be used in matching, data provided from a personal computing device, and/or any other relevant information from one or more other remote devices 910 and/or 940. Once computing device 910 performs one or more features, functions, methods, and/or steps described herein, any outputs can be transmitted to one or more computing devices 910 for entering into records.

In accordance with still other embodiments, the instructions for the processes can be stored in any of a variety of non-transitory machine readable media appropriate to a specific application.

Although specific methods of subgraph matching using active learning are discussed above, many different methods of subgraph matching using active learning can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A computer-implemented method for subgraph matching with active learning, the method comprising:
encoding vertices of a world graph into a plurality of candidate sets;
applying a first filter to each of the plurality of candidate sets to reduce the number of candidates in each of the plurality of candidate sets;
querying for a template vertex in a corresponding candidate set from the plurality of candidate sets;
capturing external information from a user concerning one or more vertices in the candidate set;
using external information to eliminate one or more candidates from the candidate set;
determining a final candidate matching the corresponding template vertex for each of the plurality of the candidate sets; and
outputting subgraph isomorphisms of template graph in the world graph based on final candidates.

2. The method of claim 1, wherein the each of the plurality of candidate sets of vertices correspond to a vertex of a template graph such that the vertex of the template graph can be mapped to a vertex in a candidate set.

3. The method of claim 1, wherein the first filter is selected from the group consisting of Node Label Filter, Node-level Statistics Filter, Topology Filter, Repeated-Sets Filter, Neighborhood Filter, and Elimination Filter.

4. The method of claim 3, wherein the choice of the filter is task-specific.

5. The method of claim 1, wherein the querying comprises using a querying algorithm to select an optimal vertex in the template graph to query.

6. The method of claim 1, wherein the querying comprises using external information to determine if the template vertex is matched.

7. The method of claim 1, wherein determining a final candidate comprises applying a second filter to reduce the number of candidates in the candidate set based upon the querying and external information.

8. The method of claim 7, wherein the second filter is the same as the first filter.

9. The method of claim 7, wherein the querying and applying a second filter are performed iteratively to determine the final candidate in the candidate set.

10. The method of claim 9, wherein each iteration of querying comprises adding the used external information into the querying algorithm.

11. The method of claim 1, further comprising determining a total number of subgraph isomorphisms (SIs) between the template graph and world graph.

12. The method of claim 10, wherein the total number of SIs is determined by a spanning-tree-based estimation.

13. The method of claim 11, wherein the spanning-tree-based estimation comprises indexing the template vertices.

14. The method of claim 1, wherein the first filter is based on basic properties of subgraph isomorphisms.

15. The method of claim 1, wherein the querying comprises selecting a querying algorithm that solves subgraph matching using the fewest number of queries.

16. A subgraph matching system using active learning, the system comprising:
a computing device, comprising:
at least one processor,
a memory; and
at least one non-transitory computer-readable media comprising program instructions that are executable by the at least one processor such that the system is configured to carry out the method of claims 1-15.
